(19) United States
(12) Patent Application Publication
(10) Pub. No.: US 2019/0180198 A1
(43) Pub. Date: Jun. 13, 2019

(54) ANALYZING DOMAIN FEATURES USING NATURAL LANGUAGE PROCESSING

(71) Applicant: International Business Machines Corporation, Armonk, NY (US)

(72) Inventors: Kelly A. Argyros, Fairfax, VA (US); Donna K. Byron, Petersham, MA (US); Lakshminarayanan Krishnamurthy, Round Rock, TX (US); Joan W. Tomlinson, Alexandria, VA (US)

(21) Appl. No.: 15/839,982

(22) Filed: Dec. 13, 2017

(51) Int. Cl. G06N 99/00; G06F 17/27

(52) U.S. Cl. CPC G06N 99/005; G06F 17/2785

(57) ABSTRACT

A method, in a data processing system comprising a processor and a memory, for analyzing domain-specific features, the method comprising receiving a selection of a domain from a client device, ingesting domain data from a data server, extracting domain elements from the domain data that correspond to the selected domain, and retrieving actionable information for the selected domain by using natural language processing and machine learning on the extracted domain elements and determining that the actionable information corresponds to the selected domain, the actionable information comprising operating parameters for the selected domain.

### BACKGROUND

The present invention generally relates to data processing, and in particular, analyzing domain-specific features using natural language processing and machine learning.

Natural language processing (“NLP”) is a field of computer science, artificial intelligence, and linguistics concerned with the interactions between computers and human (natural) languages. Many challenges in NLP involve natural language understanding, e.g., enabling computers to derive meaning from human or natural language input. Understanding human language includes understanding not only the words, but also the concepts and how they are organized.

### SUMMARY

A method, computing system, and computer program product for analyzing domain-specific features are disclosed. According to one embodiment, said method is in a data processing system comprising a processor and a memory. Said method comprises receiving, by said data processing system, a selection of a domain from a client device. Domain data is ingested from a data server by said data processing system. Domain elements are extracted from said domain data that correspond to said selected domain by said data processing system. Said method further comprises retrieving, by said data processing system, actionable information for said selected domain by using natural language processing and machine learning on said extracted domain elements and determining that said actionable information corresponds to said selected domain, wherein the actionable information comprising operating parameters for the selected domain.

Said domain may include a sphere of activity or knowledge regarding a specific subject. Said specific subject may be an industry, website, business product, a company, or a department. Said domain data may include one or more terms, acronyms, numbers, codes, or phrases from one or more files. In one embodiment, extracting said domain elements further comprises analyzing, by said data processing system, said domain data for characterizing features of said domain elements that match said selected domain, and assigning, by said data processing system, scores to said domain elements based on a degree of match to said selected domain. Said domain elements include at least one of taxonomies, ontologies, lexicons, or knowledges sources.

In another embodiment, said method further comprises receiving, by said data processing system, a refinement of said actionable information from said client device, and calibrating, by said data processing system, said natural language processing and machine learning based on said refinement of said actionable information. Said actionable information may include files containing specifications or instructions for performing or ceasing certain activities. In a further embodiment, said actionable information may include instructions for communicating messages, implementing policies, conducting data transactions, or verifying information. Said actionable information may also include compliance obligations. In yet another embodiment, said method further comprises transmitting, by said data processing system, said actionable information to a risk assessment system, and receiving, by said data processing system, a report from said risk assessment system based on said actionable information.

According to one embodiment, said computing system comprises a computer processor and a computer memory operatively coupled to said computer processor. Said computer memory having disposed within it computer program instructions that, when executed by said processor, cause said computing system to carry out the step of receiving a selection of a domain from a client device. Said processor ingests domain data from a data server. Said processor extracts domain elements from said domain data that correspond to said selected domain. Said processor further retrieves actionable information for said selected domain by using natural language processing and machine learning on said extracted domain elements and determines that said actionable information corresponds to said selected domain, wherein the actionable information comprising operating parameters for the selected domain.

Said domain may include a sphere of activity or knowledge regarding a specific subject. Said domain elements may include at least one of taxonomies, ontologies, lexicons, or knowledges sources. In one embodiment, said computing system further comprises said processor receiving a refinement of said actionable information from said client device, and calibrating said natural language processing and machine learning based on said refinement of said actionable information. Said actionable information may also include compliance obligations.

According to one embodiment, said computer program product comprises a computer readable storage medium having stored thereon program instructions executable by a processing device to cause said processing device to receive a selection of a domain from a client device. Said computer program product also comprises program instructions executable by said processing device to cause said processing device to ingest domain data from a data server. Said computer program product additionally comprises program instructions executable by said processing device to cause said processing device to extract domain elements from said domain data that correspond to said selected domain. Said computer program product further comprises said computer readable storage medium having stored thereon program instructions executable by said processing device to cause said processing device to retrieve actionable information for said selected domain by using natural language processing and machine learning on said extracted domain elements and determine that said actionable information corresponds to said selected domain, wherein the actionable information comprising operating parameters for the selected domain.

Said domain elements include at least one of taxonomies, ontologies, lexicons, or knowledges sources. In one embodiment, said computer program product further comprises program instructions executable by said processing device to cause said processing device to receive a refinement of said actionable information from said client device, and program instructions executable by said processing device to cause said processing device to calibrate said natural language processing and machine learning based on said refinement of said actionable information. Said actionable information also includes compliance obligations.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 depicts a logical block diagram of a system for analyzing domain-specific features according to one embodiment of the present invention.

FIG. 4 depicts a data flow diagram for retrieving actionable information according to one embodiment of the present invention.

FIG. 5 depicts an exemplary flow diagram of a method for analyzing domain-specific features according to one embodiment of the present invention.

### DETAILED DESCRIPTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Exemplary methods, computing systems, and computer program products for analyzing domain-specific features in accordance with the present invention are described with reference to the accompanying drawings. Risk assessment tools may be used to provide insights to an organization including the types of obligations the organization needs to be in compliance and the level of compliance risk involved when the organization is conducting its business operations in a certain market. Risk assessments reports generated using the risk assessment tools may depend on appropriate knowledge bases. For example, appropriate knowledge bases for each specific business domain may be required to generate and customize risk assessment reports for all the different types of obligations. Knowledge base systems may include a computer system that reasons and uses a knowledge base to solve complex problems. A knowledge base may comprise complex structured and unstructured information that represent facts and an inference engine that can reason about those facts and use rules and other forms of logic to deduce new facts or highlight inconsistencies.

According to embodiments of the present invention, natural language processing (“NLP”) can be used by a computer to analyze text in combination with machine-learning to facilitate understanding of human languages that are specific to particular domains. For example, a set of obligations for a business domain with which an organization is required to comply may be identified based on analysis of domain specific knowledge base, including domain ontology and taxonomies from lexicons. According to embodiments of the present invention, NLP may be used to identify and separate information pertaining to a variety of topics, genres, or subject matter that are particular to a domain. Taxonomies, lexicons, and knowledge sources may then be linked to or mapped to the corresponding domain.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

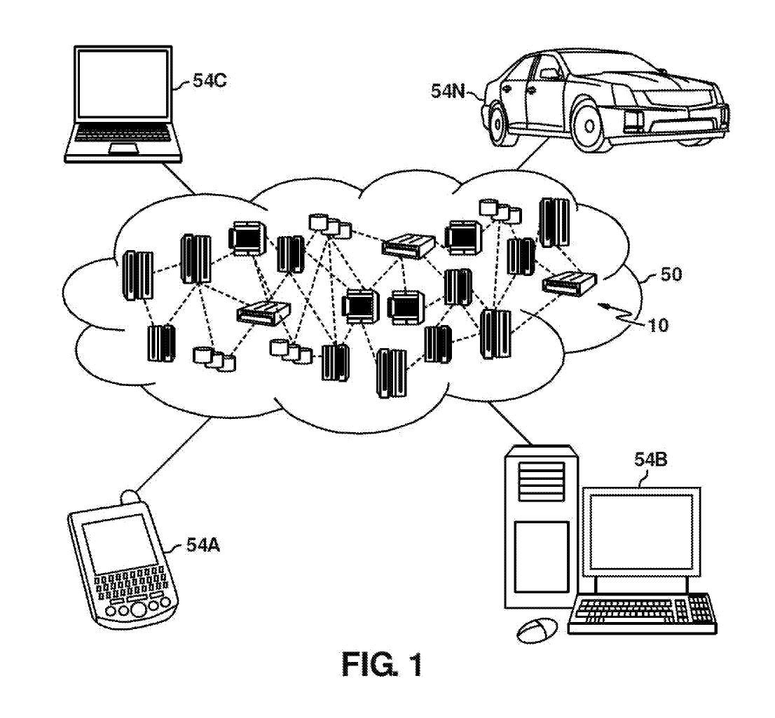

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

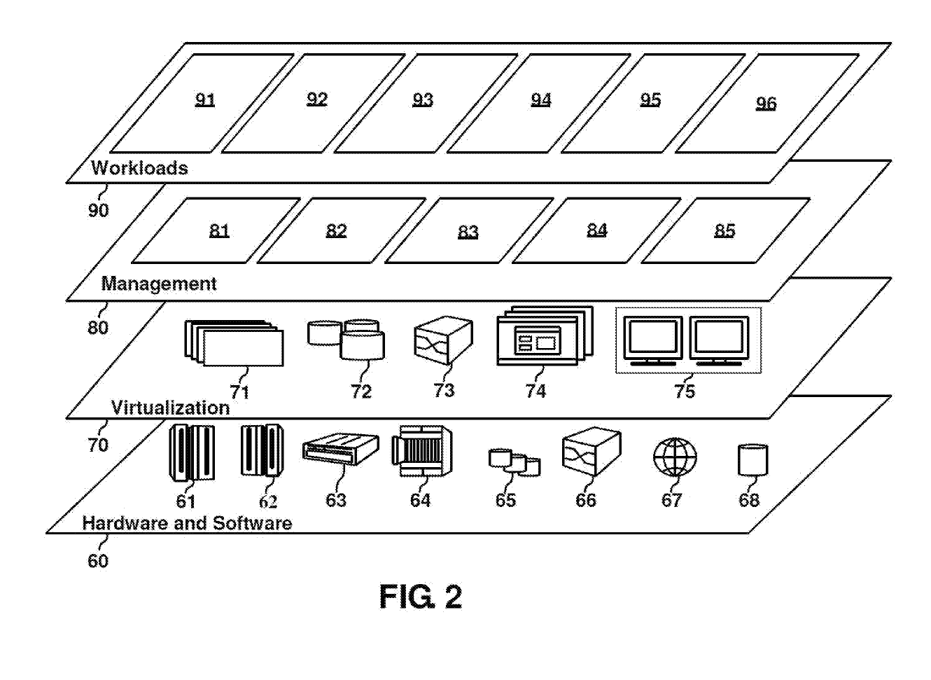

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and domain processing 96.

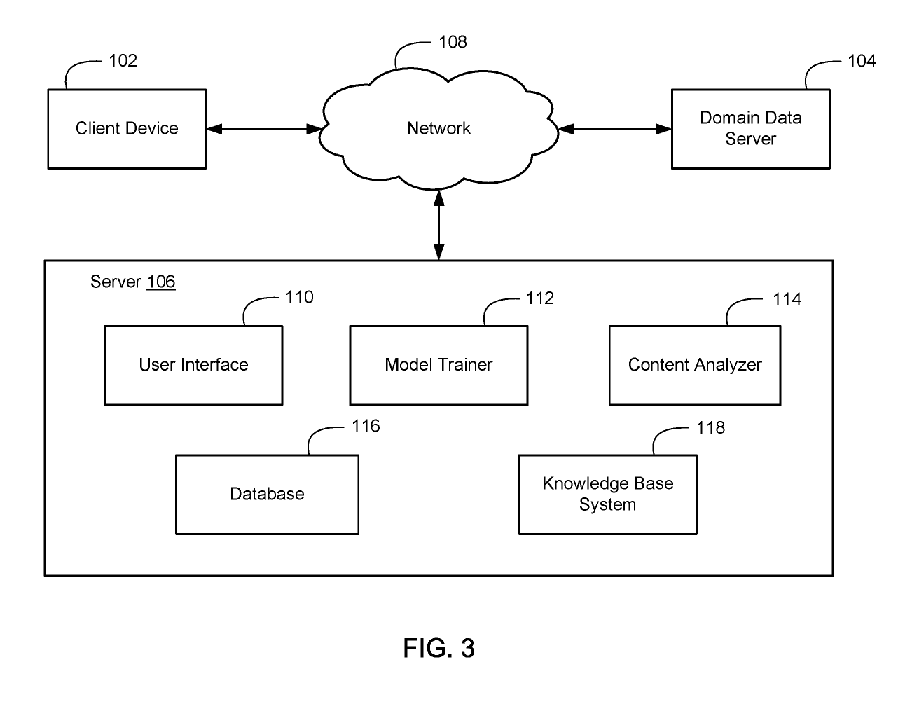

FIG. 3 presents a logical block diagram of a system for analyzing domain-specific features according to one embodiment of the present invention. The present invention is not limited to the arrangement of servers and other devices in the exemplary system illustrated in FIG. 3, but rather are for explanation. Data processing systems useful according to various embodiments of the present invention may include additional servers, routers, other devices, and peer-to-peer architectures, not shown in FIG. 3, as understood by those of skill in the art.

The system includes a client device 102 and domain data server 104 communicatively coupled to server 106 via a network 108. Client device 102 may comprise computing devices (e.g., desktop computers, terminals, laptops, personal digital assistants (PDA), cellular phones, smartphones, tablet computers, or any computing device having a central processing unit and memory unit capable of connecting to a network). Client devices may also comprise a graphical user interface (GUI) or a browser application provided on a display (e.g., monitor screen, LCD or LED display, projector, etc.). A client device may include or execute a variety of operating systems, such as personal computer operating systems (e.g., Windows, Mac OS or Linux, etc.), mobile operating systems (e.g., iOS, Android, or Windows Mobile, etc.), or the like. A client device may include or may execute a variety of possible applications, such as a client software application enabling communication with other devices, such as communicating one or more messages, such as via email, short message service (SMS), or multimedia message service (MMS).

The system further includes automated computing machinery comprising the server 106 useful in domain processing according to embodiments of the present invention. The server includes at least one computer processor or “CPU” as well as random access memory (“RAM”) which is connected through a high-speed memory bus and bus adapter to processor and to other components of the server. Stored in the RAM, or a hard drive connected to the RAM, may be a content analyzer 114 including computer program instructions that, when executed, cause the computer to identify topics of information from domain data server 104 that are directed to certain domains. A domain may be a sphere of activity or knowledge regarding a specific subject matter, such as different websites, business units, product lines, industries, companies, or departments. The content analyzer 114 can be configured to analyze domain data from domain data server 104 to identify domain elements. Domain elements may comprise characterizing features of specific domains. Examples of domain elements may include taxonomies, ontologies, lexicons, and knowledges sources.

According to one embodiment, a user of client device 102 may communicate to user interface 110 with instructions to ingest data from domain data server 104 pertaining to one or more domains. The user interface 110 may provide text fields, drop-down lists, etc., for a user at client device 102 to select domains. Domain data server 104 may comprise one or more computing devices operable to provide domain data from files, such as documents, tables, charts, illustrations, photographs, data entries, etc. The files may include features, such as terms or a combination of terms, acronyms, numbers, codes, or phrases, and so on. The features of the domain data may be compared to criteria by content analyzer 114 to determine if the features match characteristics of domain elements. For example, text in the domain data may fulfill criteria to qualify as text that relates to various domain elements.

Content analyzer 114 may identify domain elements from the domain data and link the domain elements with their respective domains. For example, a set of taxonomies, ontologies, lexicons, and knowledges sources related to equities and derivatives may be linked to an “equities and derivatives” domain. Links between domain elements and domains may comprise data structures, such as linked lists, arrays, hash tables, or graphs. The content analyzer 114 may store the domain elements, domains, and their links in data tables or records in database 116.

Client device 102 may be used to communicate with interface 110 to select domains for retrieving actionable information. The data stored in database 116 may be used by knowledge base system 118 to determine actionable information associated with a selected domain to retrieve from a corpus data server. Actionable information may comprise operating parameters according to certain requirements for a particular domain (e.g., compliance obligations). NLP and machine learning techniques may be used and applied on the domain elements stored in database 116 to determine an appropriate set of actionable information to retrieve for the selected domain. Knowledge base system 118 may comprise an artificial intelligence unit trained by model trainer 112 (e.g., using machine learning techniques such as support vector machines, neural networks, clustering, decision tree learning, etc.). Training data may be received from various entities in various ways, including, for example, from a user through a graphical user interface (“GUI”) presented on the display of the client device 102 and/or from database 116 for the purpose of gathering and compiling training data. In another embodiment, a user may customize or refine the set of actionable information determined by knowledge base system 118 for the selected domain. As such, the NLP and machine learning algorithms may be calibrated according to the customization or refinement provided by the user.

Stored in RAM also is an operating system. Operating systems useful for domain processing according to embodiments of the present invention include UNIX™ Linux™ Microsoft Windows™ AIX™ IBM's i5/OS™ and others as will occur to those of skill in the art. Non-volatile computer memory also may be implemented for such as an optical disk drive, electrically erasable programmable read-only memory (so-called ‘EEPROM’ or ‘Flash’ memory), RAM drives, and so on, as will occur to those of skill in the art.

Network 108 may be any suitable type of network allowing transport of data communications across thereof. Network 108 may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. The network 108 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine-readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client devices and servers may be encrypted using, for example, the Advanced Encryption Standard (AES) with a 128, 192, or 256-bit key size, or any other encryption standard known in the art.

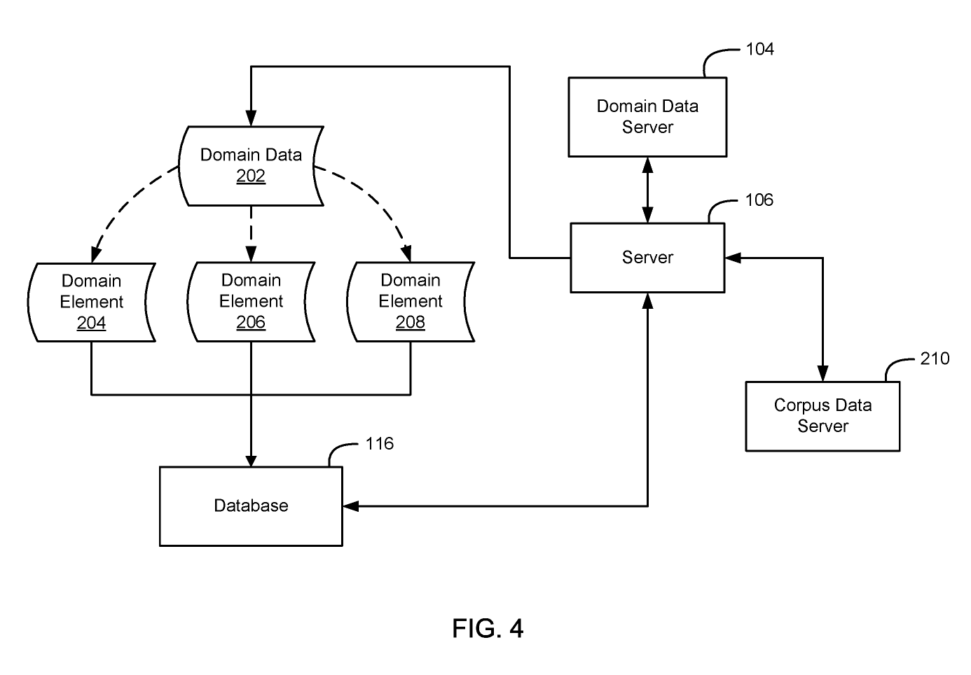

Referring to FIG. 4, server 106 may retrieve and ingest domain data 202 from domain data server 104. Domain elements 204, 206, and 208 may be extracted from the domain data 202. Examples of domain elements include taxonomies, ontologies, lexicons, and knowledges sources. The taxonomies 204, lexicons 206, knowledge sources 208 may be stored in database 116 and linked to relevant content domains. Server 202 may determine a set of actionable information from corpus data server 210 by applying NLP and machine learning algorithms to the stored taxonomies 204, lexicons 206, and knowledge sources 208 linked to the selected content domain. Accordingly, the actionable information may be specific to certain issues or topics of the selected content domain based on the identified taxonomies 204, lexicons 206, and knowledge sources 208. As an example, the actionable information may be used in conjunction with a risk rating system to generate or configure scoring models for generating assessments reports related to the content selected domain.

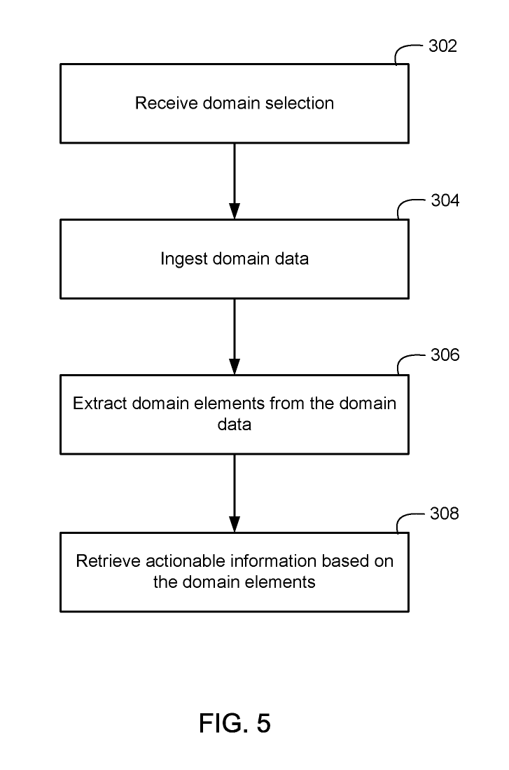

FIG. 5 depicts an exemplary flow diagram of a method for analyzing domain-specific features according to one embodiment of the present invention. A domain selection is received, step 302. The domain selection may be provided by a user from a client device to a data processing system. The domain selection may include a selection of one or more domains. A domain may include a sphere of activity or knowledge regarding a specific website, subject matter, industry, business product, company, or department.

Domain data is ingested, step 304. Ingesting the domain data may include obtaining and importing files, such as documents, tables, charts, illustrations, photographs, data entries, etc., from a data server. The files may include features, such as terms or a combination of terms, acronyms, numbers, codes, or phrases, and so on, that may be compared to criteria for matching characteristics of domain elements. Domain elements corresponding to the domain selection are extracted from the domain data, step 306. Extracting the domain elements may include analyzing the domain data for characterizing features that match the domain selection. The characterizing features may be identified by referencing a library of criteria to determine the presence of domain elements in the domain data that match the domain selection. Scores may also be assigned to the domain elements based on an evaluation of the domain elements in accordance to the criteria. The scores may comprise a value that indicates a degree to which the domain elements match the domain selection. Examples of domain elements may include taxonomies, ontologies, lexicons, and knowledge sources.

Actionable information is retrieved based on the domain elements, step 308. The domain elements may be used to retrieve actionable information for the selected domain. Retrieving the actionable information may include the data processing system applying machine learning algorithms and/or NLP to the extracted domain elements to determine actionable information that is suitable for the domain selection. For example, the data processing system may be trained to determine which actionable information corresponds to appropriate domains. The actionable information may include files containing specifications or instructions for performing or ceasing certain activities, such as scripts, commands, or computer processes for communicating messages, implementing policies, conducting data transactions, verifying information, etc. According to one embodiment, the actionable information may contain compliance obligations including laws, regulations, contractual commitments, organizational and industry standards, codes or practice, ethical codes of conduct, good governance guidelines, and agreements with community groups or non-governmental organizations. In certain instances, compliance obligations may include a plurality of sections and guidance pertaining to various domains. Accordingly, retrieving the actionable information may further comprise retrieving a subsection of a body of information that is applicable to the selected domain. In a further embodiment, the actionable information may be suitable for use by the data processing system to create reports or scoring models. For example, actionable information containing compliance obligations may be used to generate reports or create risk scoring models via an integration with or communication of the actionable information to a risk assessment system. The risk assessment system may receive the actionable information and generate reports or scoring models based on the actionable information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIGS. 1 through 5 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising a processor and a memory, for analyzing domain-specific features, the method comprising:
receiving, by the data processing system, a selection of a domain from a client device;
ingesting, by the data processing system, domain data from a data server;
extracting, by the data processing system, domain elements from the domain data that correspond to the selected domain; and
retrieving, by the data processing system, actionable information for the selected domain by using natural language processing and machine learning on the extracted domain elements and determining that the actionable information corresponds to the selected domain, the actionable information comprising operating parameters for the selected domain.

2. The method of claim 1 wherein the domain includes a sphere of activity or knowledge regarding a specific subject.

3. The method of claim 2 wherein the specific subject is selected from the group consisting of website, industry, business product, company, and department.

4. The method of claim 1 wherein the domain data includes one or more terms, acronyms, numbers, codes, or phrases from one or more files.

5. The method of claim 1 wherein extracting the domain elements further comprises:
analyzing, by the data processing system, the domain data for characterizing features of the domain elements that match the selected domain; and
assigning, by the data processing system, scores to the domain elements based on a degree of match to the selected domain.

6. The method of claim 1 wherein the domain elements include at least one of taxonomies, ontologies, lexicons, or knowledges sources.

7. The method of claim 1 further comprising:
receiving, by the data processing system, a refinement of the actionable information from the client device; and
calibrating, by the data processing system, the natural language processing and machine learning based on the refinement of the actionable information.

8. The method of claim 1 wherein the actionable information includes files containing specifications or instructions for performing or ceasing certain activities.

9. The method of claim 8 wherein the actionable information includes instructions for communicating messages, implementing policies, conducting data transactions, or verifying information.

10. The method of claim 1 wherein the actionable information includes compliance obligations.

11. The method of claim 1 further comprising:
transmitting, by the data processing system, the actionable information to a risk assessment system; and
receiving, by the data processing system, a report from the risk assessment system based on the actionable information.

12. A computing system for analyzing domain-specific features, the computing system comprising a computer processor and a computer memory operatively coupled to the computer processor, the computer memory having disposed within it computer program instructions that, when executed by the processor, cause the computing system to carry out the steps of:
receiving a selection of a domain from a client device;
ingesting domain data from a data server;
extracting domain elements from the domain data that correspond to the selected domain; and
retrieving actionable information for the selected domain by using natural language processing and machine learning on the extracted domain elements and determining that the actionable information corresponds to the selected domain, the actionable information comprising operating parameters for the selected domain.

13. The computing system of claim 12 wherein the domain includes a sphere of activity or knowledge regarding a specific subject.

14. The computing system of claim 12 wherein the domain elements include at least one of taxonomies, ontologies, lexicons, or knowledges sources.

15. The computing system of claim 12 further comprising the processor:
receiving a refinement of the actionable information from the client device; and
calibrating the natural language processing and machine learning based on the refinement of the actionable information.

16. The computing system of claim 12 wherein the actionable information includes compliance obligations.

17. A computer program product for analyzing domain-specific features, the computer program product comprising:
a computer readable storage medium having stored thereon:
program instructions executable by a processing device to cause the processing device to receive a selection of a domain from a client device;
program instructions executable by the processing device to cause the processing device to ingest domain data from a data server;
program instructions executable by the processing device to cause the processing device to extract domain elements from the domain data that correspond to the selected domain; and
program instructions executable by the processing device to cause the processing device to retrieve actionable information for the selected domain by using natural language processing and machine learning on the extracted domain elements and determine that the actionable information corresponds to the selected domain, the actionable information comprising operating parameters for the selected domain.

18. The computer program product of claim 17 wherein the domain elements include at least one of taxonomies, ontologies, lexicons, or knowledges sources.

19. The computer program product of claim 17 further comprising:
program instructions executable by the processing device to cause the processing device to receive a refinement of the actionable information from the client device; and
program instructions executable by the processing device to cause the processing device to calibrate the natural language processing and machine learning based on the refinement of the actionable information.

20. The computer program product of claim 17 wherein the actionable information includes compliance obligations.
